(19) United States
(12) Patent Application Publication
(10) Pub. No.: US 2009/0144828 A1
(43) Pub. Date: Jun. 4, 2009

(54) RAPID SIGNATURES FOR PROTECTING VULNERABLE BROWSER CONFIGURATIONS

(75) Inventor: Matthew W. Thomlinson, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/949,818

(22) Filed: Dec. 4, 2007

(51) Int. Cl. G06F 21/00

(52) U.S. Cl. 726/25

(57) ABSTRACT

Architecture for distributing rules-based, targeted vulnerability signatures to an application (e.g., a browser) in order to block exploitation of vulnerable objects (e.g., ActiveX controls) or protocols. The architecture provides a significant reduction in the window of vulnerability, thereby improving the user experience in the software products. The solution employs text in a configuration file (a realtime rule), which is fine-grained, works on both vendor-created and third-party controls, and is completely compatible except under attack conditions (and thus quick to deploy with minimal testing). Publication of the rule does not block legal uses of the vulnerable control and would not require a full testing procedure. Further, a vulnerable control with a proper vulnerability signature is as safe as running a fully-fixed control. The architecture can be extended to arbitrary binary behaviors, and shell protocols.

### BACKGROUND

A major problem for software vendors as well as customers is the continual need to address software vulnerabilities in applications. Many times vulnerabilities are discovered and used in attacks before patched software is available, leaving little opportunity for customers to protect their systems and negatively impacting their experience. For example, browser applications are experiencing an increasing number of attacks, and more specifically, in the area of third party extensibility points (e.g., ActiveX controls). The strength of an extensibility mechanism in an application (e.g., an ability of native code to interact directly with web scripting) results in an unmanaged increase in the attackable surface. In other words, the attackable surface increases as additional controls are introduced directly by the vendor or by third parties.

From the perspective of the software vendor, once a problem is reported, the solution can be difficult to resolve in a short timeline. The issue needs to be investigated to find all related issues, a fix developed, and testing performed to ensure proper behavior and application compatibility. Next, on a scheduled basis, a new control is released as well as kill-bit to keep the old control from being reintroduced onto fixed machines by malware. This process ensures the fix is complete, but takes significant time and effort by the vendor. Thus, this potentially leaves the vendor's customers exposed to attacks during this window of vulnerability.

Since the software flaws can be powerful, introduce a long window of vulnerability, involve third parties without mature response processes/distribution mechanisms, and may be cross-platform (e.g., controls existing across multiple updates to the same application), the attacks are the most common types of vulnerabilities used in drive-by attacks on the web.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture includes a method for distributing targeted vulnerability signatures to an application (e.g., a browser) in order to block exploitation of vulnerable controls (e.g., ActiveX) or protocols. The method employs text (e.g., a single line) in a configuration file (a realtime rule), is granular (e.g., can modify behavior based on properties of a parameter of a problematic control's particular method call), works on both vendor and third party controls, is minimally invasive (has high application compatibility) and thus is quick to deploy. In other words, publication of a rule does not block legal uses of the broken control and thus, does not require a full testing procedure. Further, a vulnerable control (e.g., ActiveX) with a vulnerability signature is as safe as running a fully-fixed control. The architecture can be extended to arbitrary binary behaviors and shell protocols, for example.

The architecture provides a significant reduction in the window of vulnerability under which current protection and deployment systems operate, thereby improving the user experience in the software products.

To the accomplishment of the foregoing and related ends, certain illustrative aspects are described herein in connection with the following description and the annexed drawings. These aspects are indicative, however, of but a few of the various ways in which the principles disclosed herein can be employed and is intended to include all such aspects and equivalents. Other advantages and novel features will become apparent from the following detailed description when considered in conjunction with the drawings.

### BRIEF DESCRIPTION OF THE DRAWINGS

FIG. 1 illustrates a computer-implemented protection system in accordance with the disclosed architecture.

FIG. 2 illustrates a system for addressing blocks to exploits of vulnerabilities in client and/or server systems.

FIG. 3 illustrates a system that employs a global implementation for blocking exploits of a vulnerable control across multiple applications.

FIG. 4 illustrates a more specific implementation of a system where a client browser application accesses a website.

FIG. 5 illustrates exemplary syntax for a rule.

FIG. 6 illustrates a computer-implemented method of protecting an application configuration.

FIG. 7 illustrates a method of handling a web script attack via rules-based vulnerability protection of a control.

FIG. 8 illustrates a method of modifying behavior according to different levels of granularity.

FIG. 9 illustrates a method of protecting an application from exploits.

FIG. 10 illustrates a block diagram of a computing system operable to execute rules-based processing to protect applications from exploits.

### DETAILED DESCRIPTION

One of the major customer pain points with applications continues to be receiving effective fixes in a timely manner for vulnerabilities detected in extensibility points where third parties generate application code (e.g., ActiveX control in a browser). A common environment affected by this problem is where a user browses a website. Moreover, the strengths in the extensibility of applications, for example, the ability for native code to interact directly with web scripting, results in increasing the attackable surface. The surface increases as additional controls are introduced directly by the software vendor and/or third parties.

The disclosed architecture includes a method for targeting and distributing vulnerability signatures (or rules) to an application (e.g., a browser) in order to block exploitation of vulnerable controls (e.g., ActiveX), shell protocols, arbitrary binary behaviors, etc. Further, a vulnerable control with a vulnerability rule (or signature) runs as safely as a fully-fixed control. Additionally, a small number of rules can be employed that block a much larger number of most types of vulnerabilities from exploitation. Finally, development and implementation of the protection rule does not require recompilation or access to the original source code.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof.

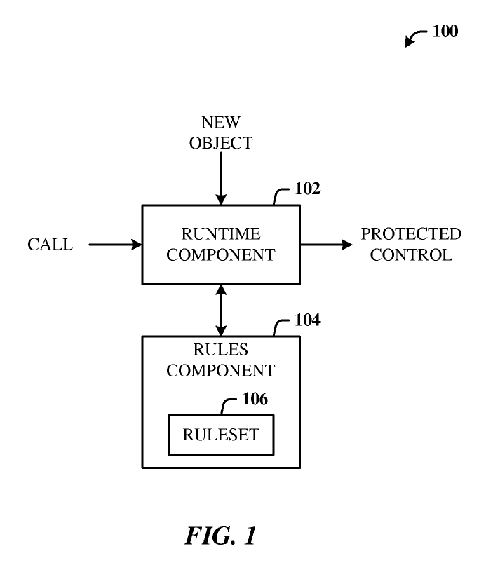

FIG. 1 illustrates a computer-implemented protection system 100 in accordance with the disclosed architecture. The system 100 includes a test component 102 for receiving a call (CALL) for a new object (NEW OBJECT) and testing the new object for a vulnerable control. A rules component 104 obtains a suitable rule from a ruleset 106, applies the rule with the control and responds to the call with the protected control. The ruleset 106 can be cached for more expedient implementation of the rule with the vulnerable control. The output of the test component 102 is then the protected control (PROTECTED CONTROL).

As part of the protection mechanism, the control gets shimmed with one or more rules in the form of filtering code during object create for filtering all data passed to the control. When used improperly (e.g., an attack is detected for that control) the filtering code filters out the improper code while passing the proper code (when used properly). Thus, application compatibility is not impacted when the control is employed in a normal and proper way.

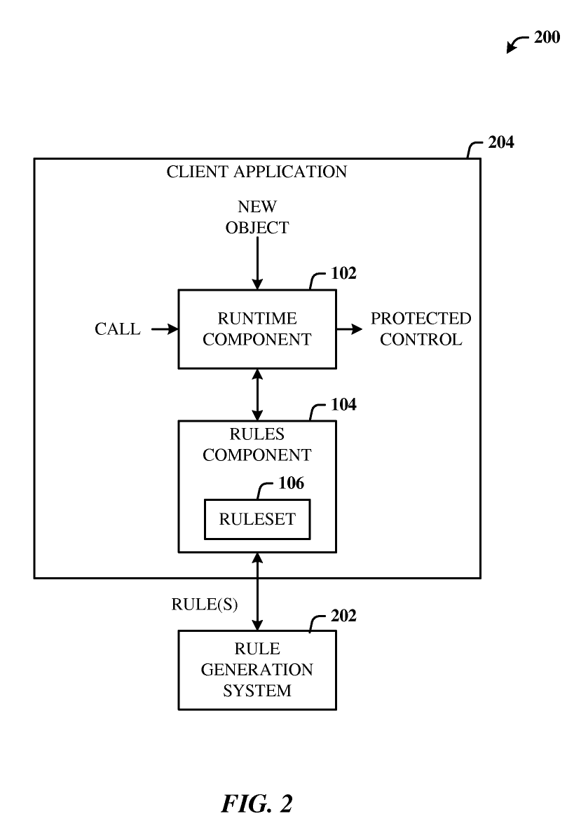

FIG. 2 illustrates a system 200 for addressing blocks to exploits of vulnerabilities in client and/or server systems. The vulnerabilities can be related to controls, protocols (e.g., shell), arbitrary binary behaviors, etc. The system 200 includes a remote rules generation system 202 (e.g., an enterprise location, software vendor location) where blocks to exploits of the vulnerable control are developed and packaged as rules and downloaded to the client 204 from a remote location. When a widespread vulnerability is detected, the rules can be pushed to the desired client applications, for example, a client application 204 such as a browser, single-purpose application (SPA) (e.g., gadget or widget), and so on. In one analysis, the disclosed rules-based technique introduces an eighty-six percent improvement in the time-to-fix over current techniques for developing, testing and distributing the fix to the end user systems. This introduces a significant reduction in the window of exploitation that customers experience.

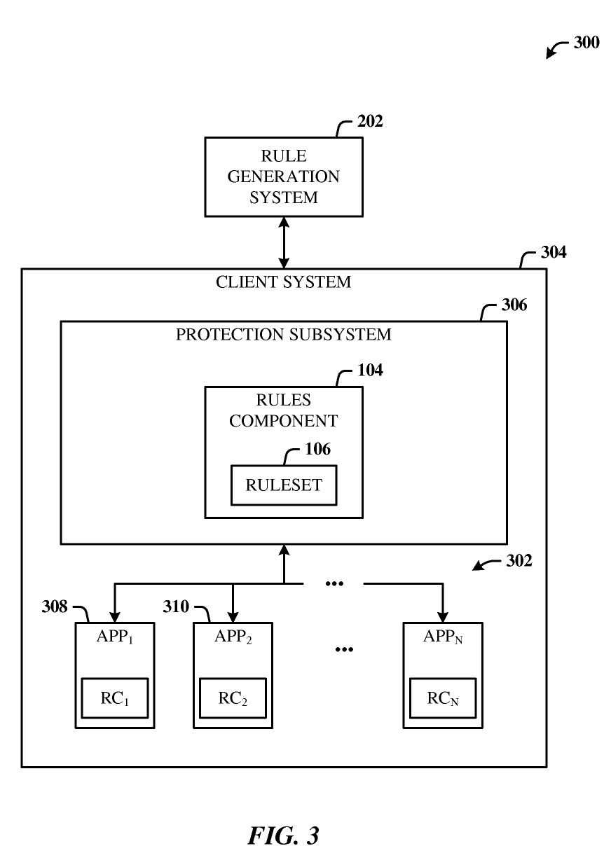

FIG. 3 illustrates a system 300 that employs a global implementation for blocking exploits to a vulnerable control across multiple applications 302 (e.g., browser, word processor, spreadsheet, etc.). Here, a client system 304 (e.g., desktop computer system) includes a protection subsystem 306 to which rules can be downloaded and from which rules can be selected and run against exploitable controls, protocols, binary behavior, etc. The protection subsystem 306 is not dedicated to a specific application of the system applications 302; this is the case where there is a central object manager. However, this is not intended to be a limitation, in that it can be the case where only rules for a specific application are employed.

It can be the case where a rule can protect vulnerabilities in a subset of the applications 302 (e.g., two applications 308 and 310), but not the remaining applications 3, . . . , N. Accordingly, other rules can be applied separately to the remaining applications or as groups, as previously described. Each of the applications 302 includes a corresponding runtime component (RC) (similar in operation and functionality to the runtime component 102 of FIG. 1). The global ruleset 106 can be configured to cache all rules needed for active applications. Alternatively, the rules associated with an application (e.g., application 308) can be stored locally with the application and cached when the application is launched.

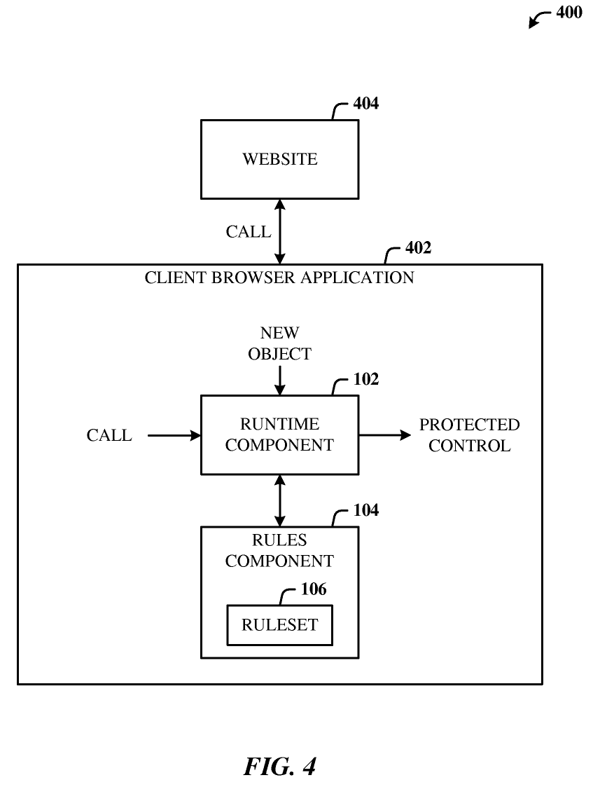

FIG. 4 illustrates a more specific implementation of a system 400 where a client browser application 402 accesses a website 404. This assumes that the vulnerability patches have been provided in the ruleset 106 for this exploitation. The disclosed solution is such that problematic controls, for example, get shimmed during object create (new ActiveXObject, CoCreateInstance . . . ) according to a downloaded ruleset and data handed to the control is filtered. Here, a web script of the website 404 sends a call to create (e.g., CoCreate) a new ActiveX object. The ruleset 106 stored in association with the client browser application 402 and cached on the client includes a suitable vulnerability patch in the form of one or more rules. The client system checks to determine if the CLSID/ProgID match existing one or more rules in the ruleset 106. Given that the one or more rules exist, creation can continue; however, any data passed to the object will be filtered through the one or more rules.

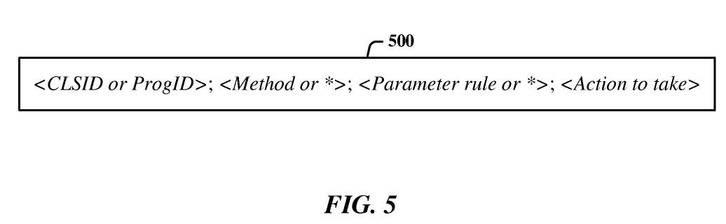

FIG. 5 illustrates exemplary syntax for a rule 500. The syntax of the rule 500 can be of the form:

<CLSID or ProgID>; <Method or *>; <Parameter rule or *>; <Action to
take>

The syntax could be expanded to allow more flexibility, for example, sitelocking can be defined for specific controls, or parameter rules can be made as complex as desired. In practice, however, a small number of rules are sufficient to cover the great majority of exploitable issues such as overly long strings or buffers, specific string content (multiple ‘\’ chars), specific values of flags, GT/EQ/LT (greater than/equal/less than) comparisons of values, and relationships between parameters.

The disclosed object creation/method shimming solution includes the following properties. The rules are granular—behavior can be blocked or modified down to a specific property, of a specific parameter, of a specific method call, and of a specific control. Rules can allow unsafe controls to run safely. Meanwhile, there is no danger of application compatibility issues for valid usage of the control. The entire control can also be disabled (“kill-bit”). The ruleset can be modified (e.g., a kill-bit recalled) if unforeseen application compatibility does occur. In each case, there is no code fix or massive test pass required, which means faster vulnerability protection turnaround. Similarly, there is no performance hit to un-shimmed controls after the single load-time check. Additionally, third-party controls can be made safe without code changes, and rules can be added and removed by third-parties vendors and enterprises. The general concept can be extended to arbitrary binary behaviors, shell protocols, and other technologies within the browser. The architecture can also be deployed down level to earlier application versions (e.g., via a BHO—binary helper object) to protect the earlier versions in the same manner.

The architecture also can be applied to other extendable interfaces where there is both a desire to block exploitation of vulnerabilities and a chokepoint for marshalling data to an object. A natural extension embodies this technique to widely deploy protections for vulnerable single-purpose applications (e.g., gadgets). Writing rules for RPC (remote procedure call) interfaces is also possible, but may require a more complex language or regular expression matching because of the more complex data formats involved.

Following are examples where the disclosed architecture can be employed. Consider an ActiveListen (by Microsoft Corporation) issue. The disclosed technique provides a quick way to disable all functionality, or just problematic functionality. In this case, ActiveListen was not designed to be called from script; thus, the simplest fix would be to develop a rule to effectively issue a kill-bit:
ActiveListen; *; *; ERROR=2

Thus, even if ActiveListen was registered on the machine, none of its methods or properties would be accessible to the web. A result of an instantiation could be ERROR_FILE_NOT_FOUND (Error 2).

Alternatively, if the desire is to only block the parameter in the case of a buffer overflow, the rule can be written differently:
ActiveListen; find; len($1)<512; ERROR=13

If the method ActiveListen.find is handed an overly long parameter, an ERROR_DATA_INVALID (Error 13) message is returned.

A second example considers an ADOdb (a database abstraction library) control flaw (e.g., ADODB.Connection). The Execute method was vulnerable to overly long strings. An underlying cause was that parameters were aliases to the same pointer and were being incorrectly freed internally. The solution is that the parameters be the same in combination with the string length to be >130 KB.

A first rule solution disallows large strings:

-ADODB.Connection.2.8; Execute; len($1) < 64000; ERROR=13
-ADODB.Connection.2.8; Execute; len($2) < 64000; ERROR=13

This restricts the lengths of the parameters to a more reasonable length. When encountering an invalid length, an ERROR_DATA_INVALID message is returned.

A second solution uses the ruleset to disallow aliases to this function:
ADODB.Connection.2.8; Execute; $2 !=$1; ERROR=13

The above rule indicates that the execute method should not be passed a second parameter that is the same as a first parameter. If an invalid length is encountered, an ERROR_DATA_INVALID message is returned.

Following are examples of third-party exploits that may affect customers, and for which rules can be quickly written and deployed.

This is an example of publicly-available exploit code for a vulnerable WinZip™ control:

```
function startWinZip(object)
{
    var xh = ‘A’;
    while (xh.length < 101) xh+=‘A’;
    xh+=“\x0c\x0c\x0c\x0c\x0c\x0c\x0c”;
    object.CreateNewFolderFromName(xh);
}
```

The exploit relies on a control vulnerability where an overly long folder name is specified. An exemplary rule follows:
WinZip; CreateNewFolderFromName; len($1)<100; ERROR=13

For a Quicktime™ pluggable protocol handler, following a similar publicly-available exploit sample:

var qt = new ActiveXObject(‘QuickTime.QuickTime’);
if (qt) {

var qthtml = ‘<object
CLASSID=“clsid:02BF25D5-8C17-4B10-BC80-

D3488ABDDC6B” width=“1” height=“1”
style=“border:0px”>’+

‘<param name=“src” value=“qt.php”>’+
‘<param name=“autoplay” value=“true”>’+
‘<param name=“loop” value=“false”>’+
‘<param name=“controller” value=“true”>’+
‘</object>’;

}

| | |
|---|---|
| qt.php: | <?xml version=“1.0”?><?quicktime type=“application/ |

x-quicktime-media-link”?><embed autoplay=“true”
moviename=“#{NEW}” qt
next=“#{YEAR}” type=“video/quicktime#{APPLE}”
src=“rtsp://
909090909090909090909090909090909090909090909090
909090909090909090909090909090909090909090909090
9090909090909090909090909090909090909090909090...

The vulnerability here is an overly long string handed to the rtsp protocol handler. An exemplary rule follows:
QuickTime.QuickTime; res://; len($src)>256; ERROR=13

Following are examples of rules that can be quickly written and applied against full-disclosure postings.

For use against ‘BlueSkyCat ActiveX Remote Heap Overflow vulnerability’:

CLSID:{2EA6D939-4445-43F1-A12B-8CB3DDA8B855};
ConnecttoServer; len($2)<512; ERROR=13

For use against ‘Macrovision FLEXnet boisweb.dll ActiveX Control Buffer Overflow Vulnerability’:

```
  CLSID:{85A4A99C-8C3D-499E-A386-E0743DFF8FB7};
DownloadAndExecute; len($2)<256; ERROR=13
  CLSID:{85A4A99C-8C3D-499E-A386-E0743DFF8FB7}; AddFileEx;
len($3)<256; ERROR=13
```

For use against ‘Computer Associates eTrust Intrusion Detection CallCode ActiveX Control Code Execution Vulnerability’ employ kill-bit by version:

| | |
|---|---|
| - | CLSID:{41266C21-18D8-414B-88C0-8DCA6C25CEA0}; *; |
| | version<3.0.5; ERROR=2 |

Following are exemplary rules that can be employed against vulnerabilities in single-purpose applications (SPAs) (e.g., gadgets). SPAs are different in that while such applications are modules of independent code, the SPA is not in the same confines as ActiveX controls. SPAs are essentially executables having many different interfaces available for attack via control instructions. This can indicate that alternative approaches can be employed for SPA interfaces.

Cross-site scripting (or XSS) in this case means an attacker can supply script to a non-malicious SPA and have the SPA act on the script. When acting on the script, the SPA is now induced to run the attacker's code as the user. The infected SPA then jumps “out of its box” by creating more powerful COM (component object model) controls such as Windows Scripting Host (WSH), and so on. Thus, the utilization of disclosed technique may be in restraining the script from jumping out of its box thereby making it more difficult for an attacker to create an interesting payload.

Following is a series of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

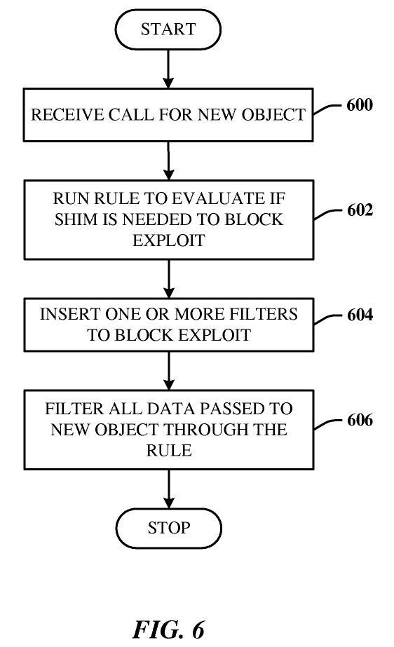

FIG. 6 illustrates a computer-implemented method of protecting an application configuration. At 600, a call is received a new object. At 602, a rule is run to evaluate if a shim is needed to block an exploit. At 604, one or more filters are inserted to block the exploit. At 606, all data passed to the new object is filtered through the rule.

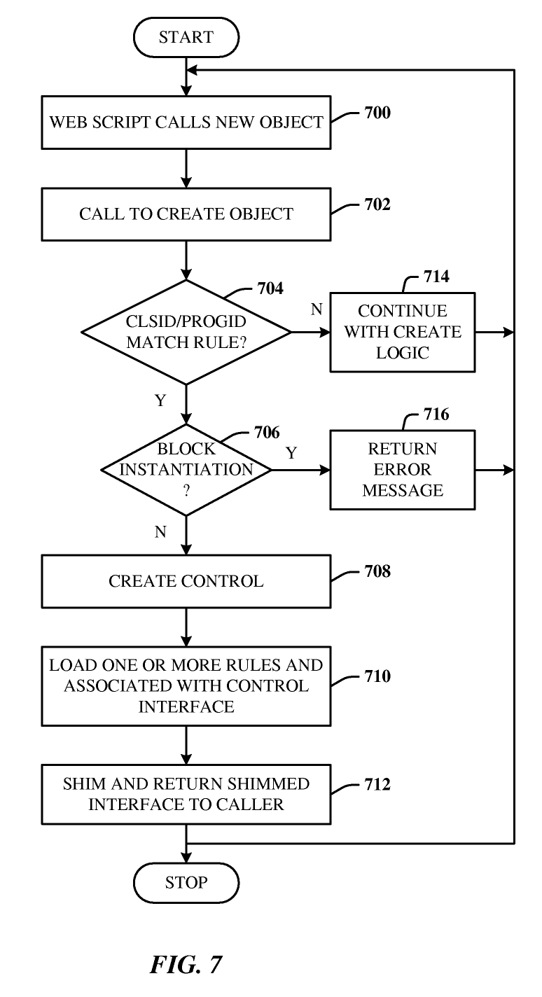

FIG. 7 illustrates a method of handling a web script attack via rules-based vulnerability protection of a control. At 700, a web script calls a new object (e.g., ActiveXObjecto). At 702, the call is processed to an object creation method (e.g., CoCreateXXX). At 704, a check is made to match an existing rule or ruleset using identifiers. For example, the matching process can include matching a CLSID (class identifier—a globally-unique identifier that identifies a COM class object) and/or ProgID (programmatic identifier—a registry entry that can be associated with a CLSID). At 704, if a rule matches, flow is to 706 to determine whether to block instantiation. If not, flow is to 708 to create the control. At 710, one or more rules associated with the control are loaded with the control interface. At 712, the interface is shimmed, and the shimmed interface is returned to the caller, to 700. Thus, data passed to the control is filtered first by the interface.

Alternatively, at 704, if a rule match is not found, flow is to 714 to continue with the create logic, and then return back to 700. If at 706, instantiation is blocked, flow is to 716 to return an error message, and then flow back to 700.

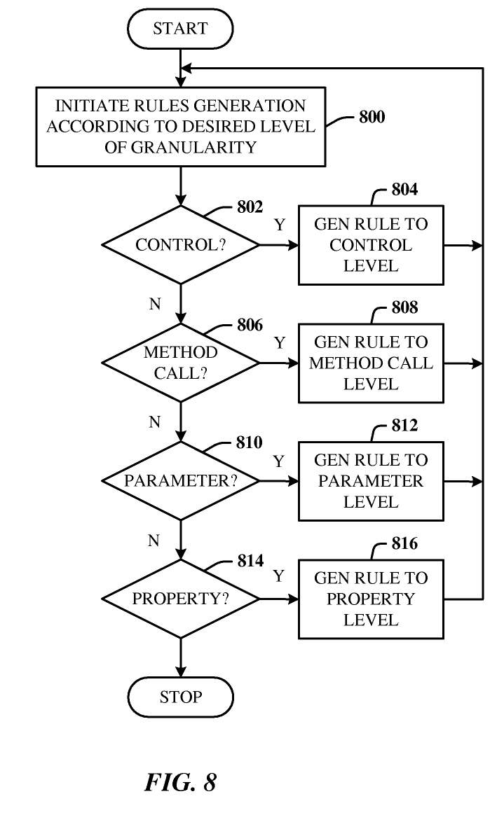

FIG. 8 illustrates a method of modifying behavior according to different levels of granularity. At 800, the rules generation process is initiated based on the desired level of granularity. At 802, the user can decide to generate a rule at the control level. If so, at 804, the rule is generated for the control, and flow is back to 800. If not, flow is to 806 where the user can decide to generate a rule at the method call level. If so, at 808, the rule is generated for the method call, and flow is back to 800. If not, flow is to 810 where the user can decide to generate a rule at the parameter level. If so, at 812, the rule is generated for the parameter, and flow is back to 800. If not, flow is to 814 where the user can decide to generate a rule at the property level. If so, at 816, the rule is generated for the property, and flow is back to 800.

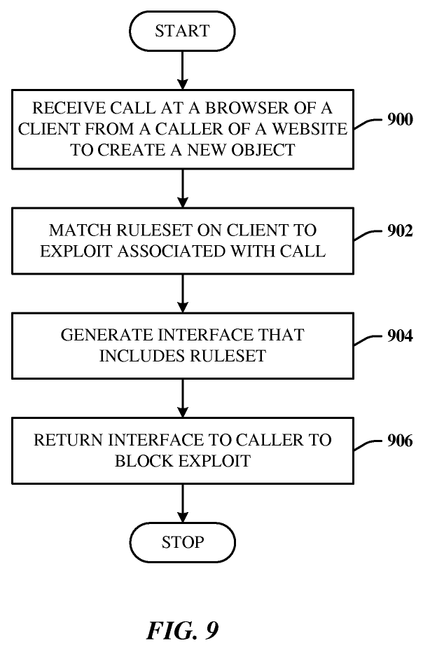

FIG. 9 illustrates a method of protecting an application from exploits. At 900, a call is received at a browser of a client from a caller of a website to create a new object. At 902, a ruleset on the client is matched to an exploit associated with the call. At 904, an interface is generated that includes the ruleset. At 906, the interface is returned to the caller to block the exploit.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

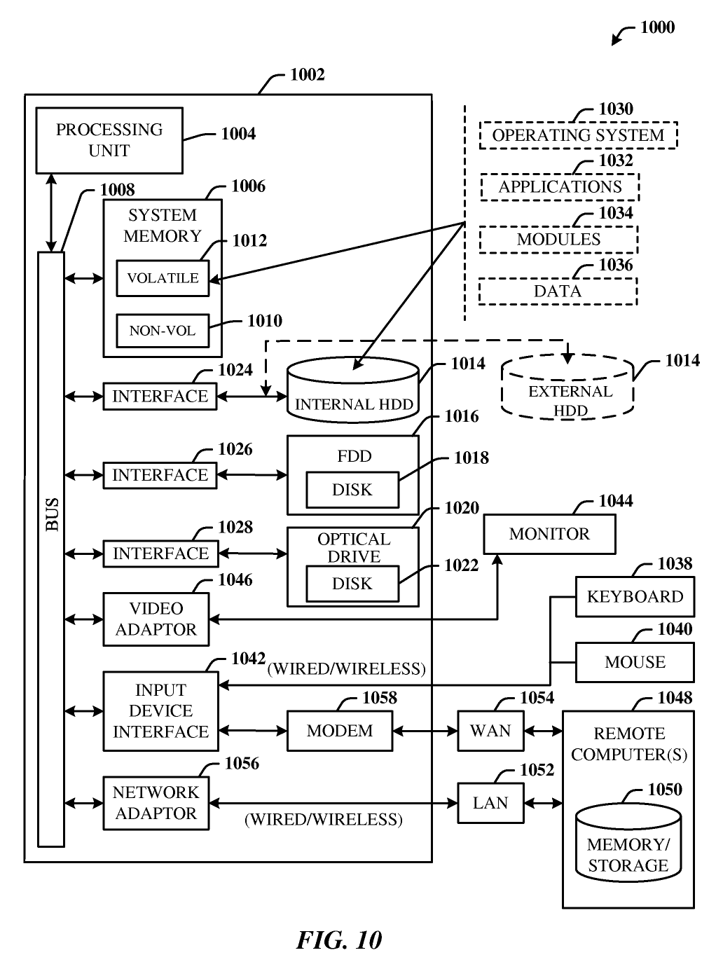

Referring now to FIG. 10, there is illustrated a block diagram of a computing system 1000 operable to execute rules-based processing to protect applications from exploits. In order to provide additional context for various aspects thereof, FIG. 10 and the following discussion are intended to provide a brief, general description of a suitable computing system 1000 in which the various aspects can be implemented. While the description above is in the general context of computer-executable instructions that may run on one or more computers, those skilled in the art will recognize that a novel embodiment also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects can also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes volatile and non-volatile media, removable and non-removable media. By way of example, and not limitation, computer-readable media can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 10, the exemplary computing system 1000 for implementing various aspects includes a computer 1002 having a processing unit 1004, a system memory 1006 and a system bus 1008. The system bus 1008 provides an interface for system components including, but not limited to, the system memory 1006 to the processing unit 1004. The processing unit 1004 can be any of various commercially available processors. Dual microprocessors and other multi-processor architectures may also be employed as the processing unit 1004.

The system bus 1008 can be any of several types of bus structure that may further interconnect to a memory bus (with or without a memory controller), a peripheral bus, and a local bus using any of a variety of commercially available bus architectures. The system memory 1006 can include non-volatile memory (NON-VOL) 1010 and/or volatile memory 1012 (e.g., random access memory (RAM)). A basic input/output system (BIOS) can be stored in the non-volatile memory 1010 (e.g., ROM, EPROM, EEPROM, etc.), which BIOS are the basic routines that help to transfer information between elements within the computer 1002, such as during start-up. The volatile memory 1012 can also include a high-speed RAM such as static RAM for caching data.

The computer 1002 further includes an internal hard disk drive (HDD) 1014 (e.g., EIDE, SATA), which internal HDD 1014 may also be configured for external use in a suitable chassis, a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as a DVD). The HDD 1014, FDD 1016 and optical disk drive 1020 can be connected to the system bus 1008 by a HDD interface 1024, an FDD interface 1026 and an optical drive interface 1028, respectively. The HDD interface 1024 for external drive implementations can include at least one or both of Universal Serial Bus (USB) and IEEE 1394 interface technologies.

The drives and associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette (e.g., FDD), and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing novel methods of the disclosed architecture.

A number of program modules can be stored in the drives and volatile memory 1012, including an operating system 1030, one or more application programs 1032, other program modules 1034, and program data 1036. The one or more application programs 1032, other program modules 1034, and program data 1036 can include the runtime component 102, rules component 104, ruleset 106, call, new object, protected control, client application 204, applications 302, client system 304, browser application 402, website 404, rule 500, and rule generation system 202. The rule generation system 202 can be a server or a desktop system, for example.

All or portions of the operating system, applications, modules, and/or data can also be cached in the volatile memory 1012. It is to be appreciated that the disclosed architecture can be implemented with various commercially available operating systems or combinations of operating systems.

A user can enter commands and information into the computer 1002 through one or more wire/wireless input devices, for example, a keyboard 1038 and a pointing device, such as a mouse 1040. Other input devices (not shown) may include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces such as a parallel port, IEEE 1394 serial port, a game port, a USB port, an IR interface, etc.

A monitor 1044 or other type of display device is also connected to the system bus 1008 via an interface, such as a video adaptor 1046. In addition to the monitor 1044, a computer typically includes other peripheral output devices (not shown), such as speakers, printers, etc.

The computer 1002 may operate in a networked environment using logical connections via wire and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wire/wireless connectivity to a local area network (LAN) 1052 and/or larger networks, for example, a wide area network (WAN) 1054. Such LAN and WAN networking environments are commonplace in offices and companies, and facilitate enterprise-wide computer networks, such as intranets, all of which may connect to a global communications network, for example, the Internet.

When used in a LAN networking environment, the computer 1002 is connected to the LAN 1052 through a wire and/or wireless communication network interface or adaptor 1056. The adaptor 1056 can facilitate wire and/or wireless communications to the LAN 1052, which may also include a wireless access point disposed thereon for communicating with the wireless functionality of the adaptor 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wire and/or wireless device, is connected to the system bus 1008 via the input device interface 1042. In a networked environment, program modules depicted relative to the computer 1002, or portions thereof, can be stored in the remote memory/storage device 1050. It will be appreciated that the network connections shown are exemplary and other means of establishing a communications link between the computers can be used.

The computer 1002 is operable to communicate with any wireless devices or entities operatively disposed in wireless communication, for example, a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi (or Wireless Fidelity) and Bluetooth™ wireless technologies. Thus, the communication can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3 or Ethernet).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented protection system, comprising:
a rules component for receiving a rule from a ruleset, the rule including a block to an exploit of a vulnerable control; and
a runtime component for processing a call for a new object and running the rule to filter data passed to the control.

2. The system of claim 1, wherein the runtime component and the rules component are employed as part of a browser application to run the rule for protection of the control.

3. The system of claim 1, further comprising a central rules generation system for developing the rule and downloading the rule to the ruleset for application against the vulnerable control.

4. The system of claim 1, wherein the ruleset includes rules for blocking exploitation of vulnerable protocols and vulnerable single-purpose applications.

5. The system of claim 1, wherein the rule blocks exploitation of vulnerability of a method call associated with the control.

6. The system of claim 1, wherein the rule blocks exploitation of vulnerability in a parameter associated with the control.

7. The system of claim 1, wherein the rule blocks exploitation of a vulnerability in a property associated with the control.

8. The system of claim 1, wherein the rule is designed and implemented by a party other than an original control author.

9. A computer-implemented method of protecting an application configuration, comprising:
receiving a call for a new object;
running a rule to evaluate if a shim is needed to block an exploit;
inserting one or more filters to block the exploit; and
filtering all data passed to the new object through the rule.

10. The method of claim 9, further comprising receiving the rule from a remote location to block exploitation of vulnerability in the control.

11. The method of claim 9, further comprising shimming a control of the new object with the rule during creation of the object.

12. The method of claim 9, further comprising recalling the rule due to an application incompatibility.

13. The method of claim 9, further comprising defining sitelocking for specific controls using one or more rules.

14. The method of claim 9, further comprising generating the rule to block exploitation of a vulnerability associated with one or more of string length and buffer length.

15. The method of claim 9, further comprising generating the rule to block exploitation of a vulnerability associated with specific string content.

16. The method of claim 9, further comprising generating the rule to block exploitation of vulnerability associated with specific flag values.

17. The method of claim 9, further comprising generating the rule to block exploitation of a vulnerability associated with a comparison of values.

18. The method of claim 9, further comprising generating the rule to block exploitation of a vulnerability associated with a relationship between parameters.

19. The method of claim 9, further comprising generating additional rules for blocking vulnerabilities and creating a chokepoint for marshalling data.

20. A computer-implemented method of protecting an application, comprising:
receiving a call at a browser of a client from a caller of a website to create a new object;
matching a ruleset on the client to a vulnerable control associated with the call;
generating an interface that includes the ruleset; and
returning the interface to the caller to block an exploit.
